(19) United States
(12) Patent Application Publication
(10) Pub. No.: US 2023/0301359 A1
(43) Pub. Date: Sep. 28, 2023

(54) Capsule with an Airflow Path for an Electronic Cigarette

(71) Applicant: JT International SA, Geneva (CH)

(72) Inventor: Peter Loveday, Epsom (GB)

(73) Assignee: JT International SA, Geneva (CH)

(21) Appl. No.: 18/021,319

(22) PCT Filed: Aug. 10, 2021
(86) PCT No.: PCT/EP2021/072231

§ 371 Date: Feb. 14, 2023

(30) Foreign Application Priority Data
Aug. 14, 2020 (EP) 20191169.0

(51) Int. Cl. A24F 40/48; A24F 40/10; A24F 40/42; A24F 7/00; A24F 40/46; A24F 40/44; H05B 3/16

(52) U.S. Cl. CPC A24F 40/48; A24F 40/10; A24F 40/42; A24F 7/00; A24F 40/46; A24F 40/44; H05B 3/16; H05B 2203/021; H05B 2203/017; H05B 2203/013

(57) ABSTRACT

A capsule has a first end to engage with an electronic cigarette device and a second end as a mouthpiece portion having a vapour outlet; the ends defining a capsule axial direction, a vaporising chamber having an air inlet and a vapour outlet; a storage reservoir to store a liquid to be vaporised and extending between the mouthpiece and the chamber; a heating element to vaporise liquid received from the reservoir; a vapour flow path extending between the chamber and the mouthpiece to allow the vapour to flow from the chamber to the mouthpiece; an airflow path extending between a capsule air inlet and the air inlet of the chamber for allowing air to flow into the chamber; a vaporisation flow path located within the chamber and extending between the air inlet and the vapour outlet and extending in a capsule direction that is perpendicular to the capsule axial direction.

### FIELD OF INVENTION

The present invention relates to an airflow path in a capsule for an electronic cigarette.

### BACKGROUND

Electronic cigarettes are an alternative to conventional cigarettes. Instead of generating a combustion smoke, they vaporize a liquid, which can be inhaled by a user. The liquid typically comprises an aerosol-forming substance, such as glycerin or propylene glycol that creates the vapor. Other common substances in the liquid are nicotine and various flavorings.

The electronic cigarette is a hand-held inhaler system, comprising a mouthpiece section, a liquid store, and a power supply unit. Vaporization is achieved by a vaporizer or heater unit which typically comprises a heating element in the form of a heating coil and a fluid transfer element, such as a wick, arranged to transfer fluid from the liquid store to the heating element. Vaporization occurs when the heater heats up the liquid in the fluid transfer element until the liquid is transformed into vapor. The vapor can then be inhaled via an air outlet in the mouthpiece.

The electronic cigarette may comprise a capsule seating which is configured to receive disposable consumables in the form of capsules. Capsules comprising the liquid store and the vaporizer are often referred to as “cartomizers”. In this case, the vaporizer of the cartomizer is connected to the power supply unit when received in the capsule seating such that electricity can be supplied to the heater of the cartomizer to heat the liquid to generate the vapor. Often some form of retaining mechanism, such as magnetic, is used to retain the capsule in the capsule seating such that it does not fall out and separate from the device.

In order to transfer liquid from the liquid store to the heating element, the wick must be arranged between the liquid store and vaporization chamber such that, when the wick is heated, capillary action transports liquid through the porous structure of the wick from the liquid store to the heating element.

It is an object of the present invention to provide a capsule for an electronic cigarette which has improved vapor generation capabilities.

### SUMMARY OF INVENTION

According to a first aspect there is provided a capsule for an electronic cigarette, the capsule having a first end configured to engage with an electronic cigarette device and a second end arranged as a mouthpiece portion having a vapour outlet; the first and second ends defining an axial direction of the capsule. The capsule further comprises a vaporising chamber having an air inlet and a vapour outlet. The capsule also includes a storage reservoir configured to store a liquid to be vaporised, the storage reservoir extending between the mouthpiece and the vaporising chamber. A heating element is housed within the vaporising chamber, the heating element being configured to vaporise liquid received from the storage reservoir and generate a vapour. A vapour flow path extends between the vaporising chamber and the mouthpiece to allow the generated vapour to flow from the vaporising chamber to the mouthpiece. An airflow path extends between an air inlet of the capsule and the air inlet of the vaporising chamber for allowing air to flow into the vaporising chamber. A vaporisation flow path located within the vaporising chamber and extends between the air inlet of the vaporising chamber and the vapour outlet of the vaporising chamber to allow vapour to flow out of the vaporising chamber, wherein the vaporisation flow path extends in a direction of the capsule that is substantially perpendicular to the axial direction of the capsule.

Advantageously, this arrangement provides an increased length of the vaporisation flow path through the vaporising chamber, resulting in a greater proportion of the vaporisation flow path being heated by the heating element. This produces a more consistent, as well as larger volume, of generated vapour. Furthermore, this configuration ensures that the capsule also remains compact.

Preferably, the vaporisation flow path extends in a direction substantially parallel to a length of the heating element. The length of the heating element may correspond to a longitudinal axis of the heating element. Thus, the vaporisation flow path extends in a direction substantially parallel to a longitudinal axis of the heating element. Advantageously, fluid flow through the vaporisation flow path is in the same direction (i.e. parallel to) the heating element, meaning that an increased length of the vaporisation flow path is heated by the heating element which helps produce a more consistent, as well as larger volume, of generated vapour.

The storage reservoir may extend in a direction substantially parallel to an axial direction of the capsule. An axial direction may also be referred to as a longitudinal direction.

The heating element may comprise a capillary-type heating element. This may facilitate efficient delivery of liquid from the storage reservoir to the vaporising chamber via capillary action.

The heating element may comprise a heating surface. Preferably, the heating surface may delimit a wall surface of the vaporising chamber. In particular, the surface of the vaporizing chamber delimited by the heating surface extends substantially along the full transversal length of the vaporizing chamber. This may help reduce the volume of the heating vaporizing chamber and optimize the function of the heating surface.

Preferably, the heating surface extends in substantially the same direction as the direction of the vaporization flow path. More preferably, this direction is substantially perpendicular to an axial direction of the capsule. Thus, the heating surface and vaporization flow path are preferably arranged parallel to each other, more preferably adjacent to each other. Contact between the vaporisation flow path and the heating surface is therefore optimized. Advantageously, this arrangement provides an increased contact surface area between the vaporisation flow path and the heating surface, resulting in a greater proportion of the vaporisation flow path being heated by the heating surface. Preferably the heating surface is oriented towards the vapour flow path such that the heating surface may be considered to face the vapour flow path.

In some examples, the heating element comprises a seal. The seal may be arranged to surround an external surface of the heating element. The seal may further be arranged to extend up the sidewalls of the heating element.

The heating element may comprise a single structure such that the heating surface and the capillary part are integral with the heating element. Since the seal may be arranged to surround the heating element, the liquid within the reservoir cannot by pass the heating surface after it has entered the heating element via the capillary part. In some cases, the seal element may be made of silicone. This may prevent liquid from the liquid capillary part or from the heating surface leaking into other components of the capsule. Preferably the seal element is positioned between the storage reservoir and the liquid capillary part. This may prevent liquid from the storage reservoir from bypassing the capillary part.

The heating surface of the heating element may comprise a heater track. The heater track may be in communication with the capillary part. This may provide an efficient method of evaporating the liquid received from the storage reservoir in order to generate a vapour.

The heater track is preferably printed on the capillary part. This provides an effective method of attaching or securing the heater track to the heating element.

Preferably, the capillary part comprises a porous ceramic. The porous ceramic may be a rigid porous ceramic. Using a rigid porous ceramic may facilitate liquid transfer between the storage reservoir and the vaporising chamber via capillary action.

The vapour flow path may comprise a vapour flow conduit. Preferably, the vapour flow conduit extends from the vapour outlet of the vaporizing chamber. More preferably, the vapour flow conduit is located next to the storage reservoir. The vapour flow conduit may there be arranged substantially parallel to the storage reservoir. This arrangement optimises the use of the internal space of the capsule.

In some cases, the vapour flow conduit may be located adjacent an external wall of the storage reservoir and preferably the vapour flow conduit may be arranged substantially parallel to the axial direction of the capsule. This arrangement optimises the length of the vapour flow path such that the vapour flow path may extend along substantially the whole length of the capsule. A longer vapour flow path allows the vapour flowing with the vapour flow path to cool down sufficiently, after leaving the vaporising chamber, before it reaches a user's mouth. This avoids potential injury to the user by inhaling vapour that is too hot.

Preferably, the vapour flow path comprises a main portion and an end portion. The main portion may extend between the vapour outlet of the vaporising chamber and the end portion, in a direction substantially parallel to the axial direction of the capsule. The end portion may extend between the main portion and the mouthpiece.

In some cases, the end portion may extend in a direction that is angled in relation to the axial direction of the capsule. This may provide a short flow path between the main portion of the vapour flow path and the mouthpiece.

In other cases, the end portion may extend in a direction that is substantially perpendicular to the axial direction of the capsule. This may increase the length of the end portion, allowing the vapour to cool before it reaches the mouthpiece.

The air flow path may comprise an air flow conduit extending between the air inlet of the capsule and the air inlet of the vaporising chamber. Preferably, the air flow conduit is located adjacent the heating element. The arrangement makes optimal use of the space within the capsule by arranging features substantially next to each other.

Preferably, the air flow conduit is substantially parallel to an axial direction of the capsule. This configuration may provide a direct flow path between the air inlet and the vaporising chamber for air entering the capsule, ensuring that the air reaches the vaporising chamber quickly and efficiently. A substantially straight, or direct, flow path reduces turbulence within the air flow, and so air flow into the vaporising chamber is smoother.

The vapour flow path and air flow path are preferably located substantially on opposite sides of a median plane. In this case, median plane may be a plane that passes substantially through the vapour outlet in the mouthpiece of the capsule.

The median plane may be considered as being in alignment with a substantially central longitudinal axis of the capsule. This arrangement provides a maximal transverse length along which the vaporisation flow path, which is located between the air flow path and the vapour flow path, can extend. Thus the arrangement optimises the length of the vaporisation flow path.

In some examples, the capsule may comprise a buffer reservoir in fluid communication with the storage reservoir. The buffer reservoir may store an additional volume of liquid to be vaporised. The buffer reservoir may therefore act as an additional supply, or source, of liquid to be vaporised. The heating element may be arranged to contact liquid stored in the buffer reservoir. This may allow the heating element to vaporise the liquid within the buffer reservoir in order to generate a vapour.

In some examples, the air flow path may be formed by a seal element and a holder of the capsule. The air flow path may therefore be formed out of components that are already present within the capsule, rather than requiring additional components to form the air flow path. The seal element may be the same as the sealing element for the capillary part. The seal element may be formed from a single piece for example e.g. a single silicone piece. This may reduce the number of individual components within the capsule, resulting in a less complex capsule that is cheaper to manufacture.

Preferably, the vaporising chamber may comprise at least one turbulence element arranged to disrupt the air flow through the vaporising chamber. Creating turbulence within the vaporising chamber may improve mixing between the air received in the air inlet and the liquid which has been evaporated by the heating element. The increase in mixing may improve the generation of the vapour to be inhaled by the user.

The at least one turbulence element may comprise at least one electrical contact which extends in a traversal direction of the vaporising chamber. Thus, the electrical contact may perform the additional function of creating turbulence within the vaporising chamber, as well as providing an electrical connection between the capsule and an electronic cigarette device. This may reduce the number of separate components within the capsule, reducing the complexity of the capsule as well as the manufacturing costs.

According to another aspect there is provided an electronic cigarette comprising a main body and a capsule wherein the main body comprises a power supply unit, electrical circuitry, and a capsule seating configured to connect with the capsule, the capsule comprising: a first end configured to engage with the electronic cigarette device and a second end arranged as a mouthpiece portion having a vapour outlet; the first and second ends defining an axial direction of the capsule, the capsule further comprising: a vaporising chamber having an air inlet and a vapour outlet; a storage reservoir configured to store a liquid to be vaporised, the storage reservoir extending between the mouthpiece and the vaporising chamber; a heating element housed within the vaporising chamber, the heating element configured to vaporise liquid received from the storage reservoir and generate a vapour; a vapour flow path extending between the vaporising chamber and the mouthpiece to allow the generated vapour to flow from the vaporising chamber to the mouthpiece; an airflow path extending between an air inlet of the capsule and the air inlet of the vaporising chamber for allowing air to flow into the vaporising chamber; a vaporisation flow path located within the vaporising chamber and extending between the air inlet of the vaporising chamber and the vapour outlet of the vaporising chamber to allow vapour to flow out of the vaporising chamber; wherein the vaporisation flow path extends in a direction of the capsule that is substantially perpendicular to the axial direction of the capsule.

There may be provided an electronic cigarette comprising a capsule according to any of the above described capsules.

### BRIEF DESCRIPTION OF DRAWINGS

Embodiments of the present invention will now be described by wait of example with reference to the accompanying drawings in which:

FIG. 1a shows a perspective view of part of a capsule for an electronic cigarette;

FIG. 1b shows an exploded perspective view of a capsule for an electronic cigarette;

FIG. 1c shows a perspective view of a capsule for an electronic cigarette;

FIG. 2a shows a perspective view of a seal element of a capsule for an electronic cigarette;

FIG. 2b shows a perspective view of a holder of a capsule for an electronic cigarette;

FIG. 3a shows an exploded perspective view of a lower housing portion of a capsule for an electronic cigarette;

FIG. 3b shows a perspective view of a lower housing portion of a capsule for an electronic cigarette;

FIG. 3c shows a perspective view of a lower housing portion of a capsule for an electronic cigarette;

FIG. 4a shows a cross sectional view of a capsule for an electronic cigarette; and

FIG. 4b shows a cross sectional view of part of a capsule for an electronic cigarette.

### DETAILED DESCRIPTION

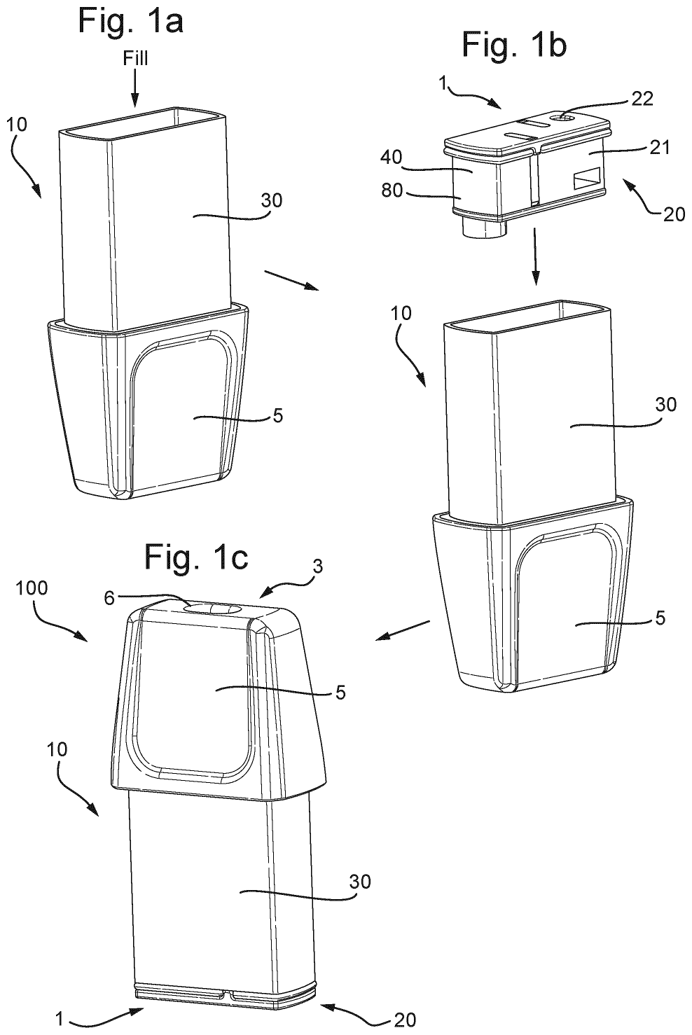

FIG. 1c illustrates a capsule 100 for an electronic cigarette. As most clearly shown in FIG. 1b the capsule 100 comprises an upper housing portion 10 and a lower housing portion 20 which are configured to connect together. The capsule has a first end 1 configured to engage with an electronic cigarette device and a second end 3 arranged as a mouthpiece portion 5 having a vapour outlet 6.

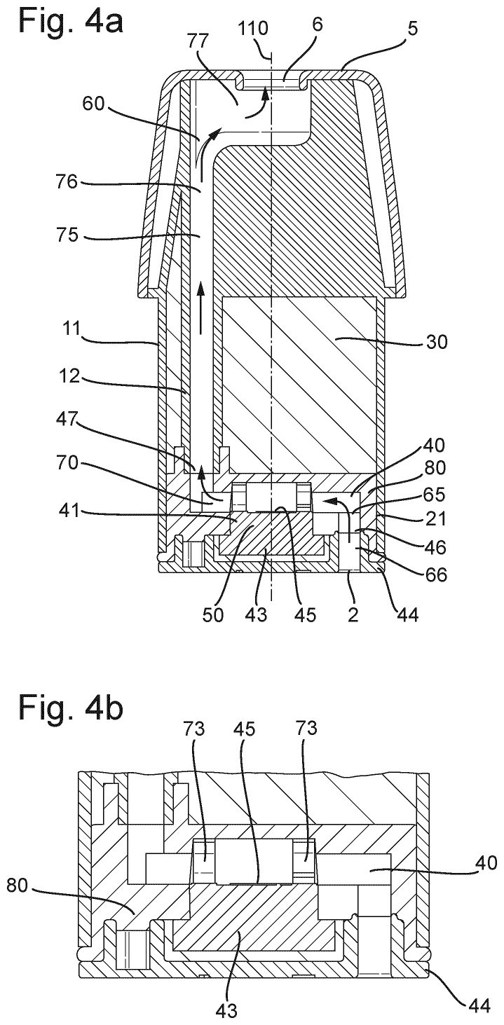

The upper housing portion 10 includes a storage reservoir 30 arranged to contain a liquid to be vaporised. The lower housing portion 20 includes a vaporising chamber 40, where the vaporising chamber 40 has an air inlet 46 and a vapour outlet 47, as shown in FIG. 4a. A fluid transfer element 50 is positioned between the storage reservoir 30 and the vaporising chamber 40, and is arranged to transfer liquid between the storage reservoir 30 and the vaporising chamber 40 by capillary action. The fluid transfer element 50 may comprise a heating element 41 and is located within the vaporising chamber 40 and is arranged to heat the liquid that is transferred by capillary action to the vaporising chamber 40 by the fluid transfer element. The heating element 41 therefore vaporises the liquid in order to generate a vapour.

In some examples, as well as a storage reservoir 30, the capsule 100 includes a buffer reservoir (not shown) arranged to store an additional volume of liquid for vaporisation. A liquid conduit provides a fluid connection between the buffer reservoir and the storage reservoir 30.

The fluid transfer element 50 generally takes the form of a capillary-style wick which is configured to transport liquid from the storage reservoir 30 through to the vaporising chamber 40 via capillary action through the wick structure, driven by the evaporation of liquid from the centre of the wick by the heating element 41. Generally, the fluid transfer element 50 has an elongate form which extends across the internal volume of the vaporising chamber 40. In this way, when the upper and lower housing portions are brought together as shown in FIG. 1b and the internal volume of the storage reservoir 30 is filled with liquid as shown in FIG. 1a, the fluid transfer element 50 is in fluid communication with the liquid within the internal volume of the storage reservoir 30 and so liquid is drawn into the vaporising chamber 40 through the fluid transfer element 50 during heating.

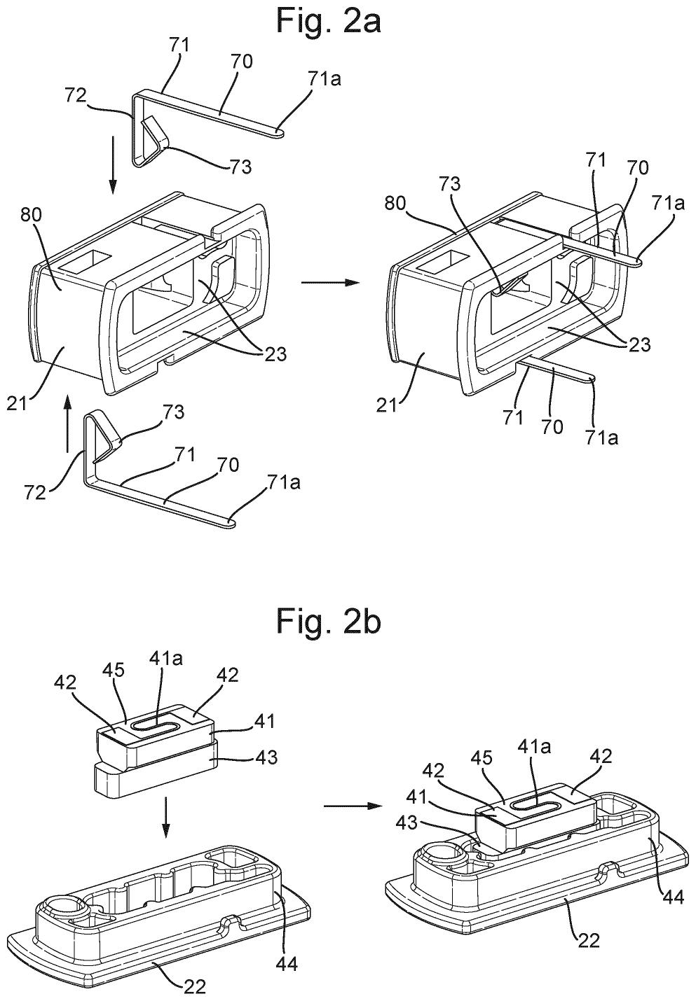

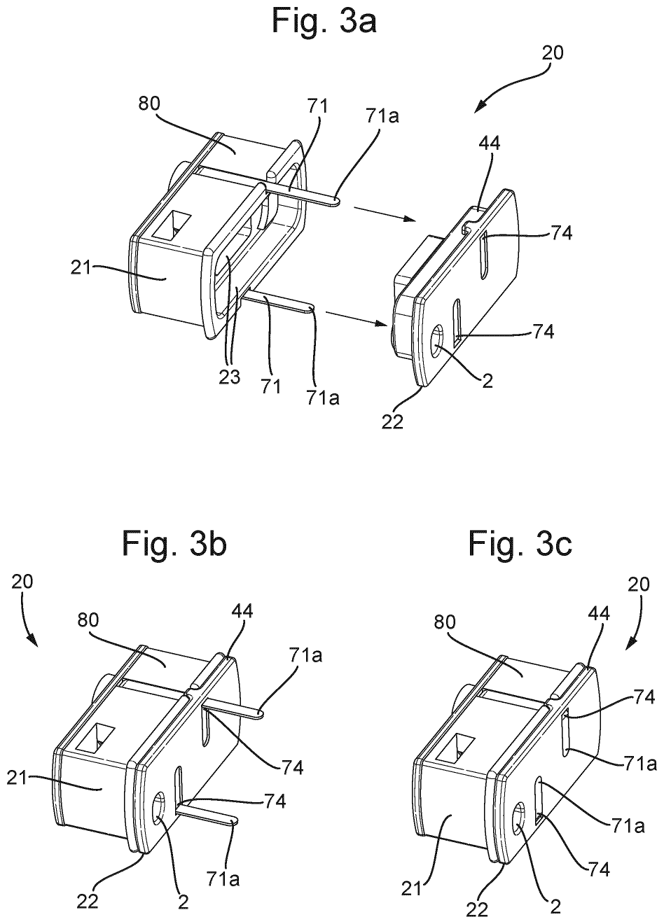

The lower housing portion 20 comprises a seal element 80 and a holder 44, as shown in FIGS. 3a-3c. The seal element 80 has an outer housing wall 21 defining the outer bounds of the lower housing portion 20. As most clearly shown in FIG. 2A the seal element 80 also has a number of internal walls 23 which area arranged to engage with the holder 44.

As can be seen from FIGS. 1b and 1c, two integral housing portions, i.e. the upper and lower housing portions 10, 20, together form the outer housing of the capsule 100 as well as each of the vaporising chamber 40 and storage reservoir 30. This configuration simplifies the assembly of the capsule because the insertion of separate components within the outer housing, for example to provide the vaporising chamber or the storage reservoir, is not required. Furthermore, the alignment of components, which when not precisely achieved can lead to leakage, can be more accurately achieved by having fewer individual and separately installable components.

As shown, for example, in FIG. 2b, the heating element 41 comprises two contact ends 42 which are arranged to contact first and second electrical contact elements 70. The contact ends 42 are spaced apart in the transversal direction of the capsule. By providing power to the electrical contact elements 70 and subsequently to the heating element 41 the current can be provided through the heating element 41 to heat the heating element 41 and vaporise a liquid transported from the storage reservoir 30 through the fluid transport element 50 within the vaporising chamber 40. The heating element 41 is held within the holder 44 which forms the base 22 of the lower housing portion 20.

As can be seen in FIG. 2a, each electrical contact element 70 comprises a longitudinally extending portion 71 which extends substantially parallel to a longitudinal axis of the capsule 100 and a base portion 72 which extends substantially perpendicular to a longitudinal axis of the capsule 100. As can be seen in FIG. 2a, the base portion 72 of each contacting plate 70 comprises a folded region 73 having a substantially triangular shape. The folded region 73 of each electrical contact element 70 is arranged to come into contact with the two ends 42 of the heating element 41.

The electrical contact elements 70 provide the additional function of coupling the seal element 80 to the holder 44 of the lower housing portion 20. As shown in FIGS. 3a and 3b, each longitudinally extending portion 71 passes through a corresponding aperture 74 in the holder 44. The free ends 71a of the longitudinally extending portions 71 are then folded such that they lie substantially flush with an external surface of the base 22, as shown in FIG. 3c. The free ends 71a of the electrical contact elements 70 therefore hold the holder 44 and seal element 80 together to form the lower housing portion 20.

The electrical contact elements 70 are therefore arranged in a substantially U-shaped manner, having a vertically extending portion (i.e. the longitudinally extending portions 71) and two horizontally extending portions (i.e. the base portion 72 and the free ends 71a). It should be noted that vertical and horizontal directions are defined with reference to the capsule when it is held in its operative configuration, as shown in FIG. 1c. Thus, both the base portion 72 and the free ends 71a extend in a direction substantially perpendicularly to the longitudinally extending portion 71. The base portion 72 and the free ends 71a are substantially parallel to each other.

In this way when the capsule 100 is received in an aerosol generating device, for example a main body of an electronic cigarette, the free ends 71a of the electrical contact elements 70 are exposed through the lower housing portion 20, as shown in FIG. 3c, such that they may contact corresponding electrical contacts which are connected to the battery of a base device in order to provide current through the contact plate 70 to the heating wire 41.

Further details of the heating element 41 and the flow path through the capsule 100 will now be described.

As shown in FIG. 4a, the capsule comprises a fluid pathway 60 which extends from an air inlet 2 of the capsule 100 to the outlet 6 in the mouthpiece 5. The fluid pathway 60 comprises an airflow path 65, a vaporisation flow path 70, and a vapour flow path 75. The airflow path 65 extends through the holder 44 between the air inlet 2 of the capsule 100 and an inlet 46 of the vaporising chamber 40, in order to allow air to enter the vaporising chamber 40. The vaporisation flow path 70 extends through the vaporising chamber 40 between the inlet 46 and a vapour outlet 47 of the vaporising chamber 40. The vapour flow path 75 extends through the upper housing portion 10 between the vapour outlet 47 and the mouthpiece 5, in order to allow the generated vapour to flow from the vaporising chamber to the mouthpiece 5.

As shown in FIG. 4a the holder 44 of the lower housing portion comprises a tubular wall 66 extending through the holder 44, which defines the airflow path 65 The airflow path 65 may be thought of as a tubular passageway or conduit aligned with the elongate axis 110 of the capsule 100. In other words, the airflow path 65 is substantially parallel to a longitudinal axis of the capsule 100. The airflow path 65 extends partially into the seal element 80 in order to fluidly connect with the inlet 46 of the vaporising chamber 40.

Similarly, as shown in FIG. 4a, the upper housing portion 10 includes an outer wall 11 forming the outer boundary of the storage reservoir 30 and a tubular wall 12 which defines the vapour flow path 75 extending between the vaporising chamber 40 and the mouthpiece 5. The vapour flow path 75 may be thought of as a tubular passageway or conduit aligned with the elongate axis of the capsule 100. In other words, the vapour flow path 75 is substantially parallel to a longitudinal axis of the capsule 100.

The vaporisation flow path 70 extends in a direction that is substantially perpendicular to an axial direction (i.e. a longitudinal axis) of the capsule 100. The vaporisation flow path 70 may therefore be thought of as a transversal passageway. By arranging the vaporisation flow path 70 transversally rather than longitudinally through the capsule, the length of the vaporization flow path 70 is increased. That is to say, for a given longitudinal dimension, a horizontally arranged vaporisation flow path 70 results in a longer flow path between the airflow path 65 and the vapour flow path 75, compared to a vertically arranged vaporisation flow path 70. It should be noted that vertical and horizontal directions are with reference to the capsule when it is held in its operative configuration, as shown in FIG. 1c. Thus, this arrangement increases the length of the vaporisation flow path 70 across the heating element 41. The heating element 41 is therefore exposed to a longer vaporisation flow path 70 allowing a more consistent, as well as a greater volume, of vapour to be generated.

As a result of the transversal passageway defined by the vaporisation flow path 70, the airflow path 65 and the vapour flow path 75 are offset from each other, as shown in FIG. 4a. Said another way, the airflow path 65 and the vapour flow path 75 can be thought of as being located on each side of a median plane that passes through the outlet 5 of the mouthpiece 6, bisecting the width of the capsule 100.

Due to the offset, the airflow path 65 is located towards one side of the capsule, as show in in FIG. 4a. The airflow path 65 is therefore located next to the heating element 41, which is located substantially centrally within the holder 44. The air inlet 2 is also located towards the same side of the capsule 100, in order to fluidly connect with the airflow path 65.

Further as a result of the offset, the vapour flow path 75 is also located towards a side of the capsule, as shown in FIG. 4a. This allows the vapour flow path 75 to extend along substantially the whole length of the capsule. Since the transversal vaporisation flow path 70 does not extend along a length of the capsule, the vapour flow path 75 is able to extend along the majority of the length of the capsule 100, as shown in FIG. 4a. This arrangement therefore provides an increased vapour flow path 75 length compared to an arrangement in which the vaporisation flow path 70 and the vapour flow path 75 were both longitudinally extending. In some cases, this can result in an increased vapour flow path 75 length of around 40% compared to arrangements in which the airflow path, the vaporisation flow path, and the vapour flow path are all aligned. By providing a longer vapour flow path 75, the amount of time taken for the generated vapour to travel from the vaporisation chamber 40 to the mouthpiece 5 is increased, and so the generated vapour has a greater length of time over which to cool down, reducing the chance of the user injuring themselves by inhaling hot vapour. The offset arrangement of the vapour flow path 75 also reduces spitting.

The storage reservoir 30 is therefore arranged to occupy a portion of the remaining space in the internal cavity of the capsule 100. This can be achieved by having a storage reservoir 30 which extends in a direction substantially parallel to a longitudinal axis of the capsule 100, providing a large volume in which to receive and store liquid to be vaporised. Thus, as shown in FIG. 4a, the vapour flow path 75 is located next to the storage reservoir 30. More specifically, the vapour flow path 75 is located adjacent to an external wall of the storage reservoir 30 and extends in a direction that is substantially parallel to the longitudinal axis of the capsule 100 and therefore substantially parallel to the extension of the storage reservoir 30.

Positioning the vapour flow path 75 towards one side of the capsule 100 has the effect that the vapour flow path 75 is offset from the outlet 6 in the mouthpiece 5. In order to allow the vapour within the vapour flow path 75 to exit the capsule 100 through the mouthpiece 5, the vapour flow path 75 needs to fluidly connect with the outlet 6 in the mouthpiece 5. This is achieved by re-directing the vapour flow path 75 from its offset position to a more central position, substantially in line with the mouthpiece outlet 6. The vapour flow path 75 can therefore be thought of as comprising a main portion 76 and an end portion 77. The main portion 76 extends between the vapour outlet 47 of the vaporising chamber 40 and the end portion 77, and the end portion 77 extends between the main portion and the mouthpiece outlet 6. The main portion 76 of the vapour flow path is located adjacent the storage reservoir 30, as described above.

FIG. 4a shows the end portion 77 of the vapour flow path 75 extending in a direction that is substantially perpendicular to a longitudinal axis of the capsule 100, allowing the main portion 77 of the vapour flow path 75 to be connected with the mouthpiece 77. However, in some examples, the end portion 77 may be angled with respect to the longitudinal axis of the capsule 100, as this provides a shorter flow path between the main portion of the vapour flow path 75 and the mouthpiece 5.

Thus, in summary, air flow through the capsule has been arranged such that air is drawn in to the capsule in a substantially vertical direction and then flows in a horizontal direction along the vaporisation flow path 70 along the longest length of the ceramic heating element 41. After flowing along the heating element 41, the vapour is drawn vertically up the offset vapour flow path 75, flowing along the inside edge of the capsule 100. As shown in FIG. 4a, there is a corner formed at the connection point between the vaporisation flow path 70 and the vapour flow path 75. This abrupt change in direction helps to filter out large particles present within the vapour, increasing the quality of the vapour that is inhaled by the user. The vapour is finally re-directed along the end portion 77 to the substantially centralised outlet 6 in the mouthpiece 5.

As has been mentioned previously, the heating element 41 comprises a capillary type heating element having two ends 42. The heating element 41 includes a liquid capillary part 43 which is arranged to receive the liquid to be vaporised from the storage reservoir 30 and a heating surface 45 which is arranged to vaporise the received liquid. The liquid capillary part 43 therefore carries out the function of the previously described fluid transfer element 50. The heating surface 45 delimits a surface of the vaporising chamber 40, in particular, the boundary between the vaporising chamber 40 of the seal element 80 and the holder 44.

In order to aid transfer of the liquid between the storage reservoir 30 and the heating surface 45, the heating surface 45 and the liquid capillary part 43 are in fluid communication with each other. To facilitate the transfer, the heating surface and the liquid capillary part 43 are formed from a rigid, porous ceramic, which transports the liquid from the storage reservoir 30 via capillary action through the porous structure, driven by the evaporation of liquid by the heating element 41. The heating temperature at the surface of the heating surface 45 is homogeneous due to the latent heat created.

A heater track 41a is printed directly onto the heating surface 45, between the two contact ends 42 of the heating element 41. The heater track 41a vaporises the received liquid which the liquid vapour to be generated within the vaporising chamber 40, which then flows along the vaporisation flow path 70 and out of the vaporising chamber 40.

Since the heating surface 45 is the surface of the heating element 41, which is a ceramic block, the heating surface 45 is porous. In particular the heating element 41 can be considered as a single structure, in this case a ceramic block, having an upper portion (which can be referred to as the heating surface 45) on which the heating track 41a is printed and a lower portion (which can be referred to as the liquid capillary part 43) which is inserted in the liquid sump. The lower portion is more elongated than the upper portion. Liquid is transferred by capillarity of the porous structure to the uppermost surface where the heating track 41a is present. The liquid capillary part 43 and the heating surface 45 are therefore integrally formed with the heating element 41.

The heating surface 45 is a substantially planar surface, extending in a direction that is substantially perpendicular to a longitudinal axis of the capsule 100, as shown in FIG. 4a. The heating surface 45 is therefore substantially parallel to the vaporisation flow path 70. This arrangement results in an increased flow length, and thus increased flow duration, over the heater track 41a, which ensures that a large proportion of the vaporisation flow path 70 is being heated by the heater track 41a on the heating surface 45. The transversal arrangement of the vaporisation flow path 70 substantially parallel to and substantially adjacent to the heating surface 45 therefore provides an increased air-heater contact duration time which leads to improved vapour generation.

Importantly, the vaporisation flow path 70 is arranged perpendicular to the longitudinal axis of the capsule 100 but parallel to the length of the heating surface of the heating element 41. The heating surface 45 essentially extends in transversal direction and the air flows in the same direction, through the vaporisation flow path 70.

Furthermore, the heating element 41 has a liquid capillary part 43, which can be thought of as a liquid loading surface, which is opposite to the heating surface 45 of the heating element 41 which is in contact with air flow. This means that, by capillary action, the liquid is drawn homogeneously through the liquid capillary part 43 to the heating surface 41. As a result, the liquid gradient at the heating surface 41 in contact with the air is minimized. Thus, the alignment of the heating surface with the air flow is optimised.

As previously discussed with reference to FIG. 2a, each electrical contact element 70 comprises a folded region 73. As shown more clearly in FIG. 4b, these folded regions 73 are located within the vaporising chamber 40. As a result of the folded structure, the folded regions 73 disrupt the air flow through the vaporising chamber 40. The folded regions 73 may therefore be referred to as turbulence elements 73 arranged to create turbulence within the vaporising chamber 40. The electrical contact elements 70 are therefore able to provide the additional function of creating turbulence within the vaporising chamber 40 in order to promote mixing of the air received via the inlet 2 and the evaporated liquid, in order to g=form the generated vapour to be inhaled by the user.

As shown more clearly in FIG. 2a, the turbulence elements 73 extend across a width of the vaporising chamber in a direction that is perpendicular to the vaporisation flow path 70. This arrangement creates turbulence across the vaporisation flow path 70, improving mixing.

As the skilled person will appreciate, the capsule described above, and any of its modifications, can be used as part of an electronic cigarette. For example, an electronic cigarette comprises a main body having a power supply, electrical circuitry, and a capsule seating. The capsule seating of the main body is arranged to engage with and electrically connect with the first end of the capsule described above.

1. A capsule for an electronic cigarette, the capsule having a first end configured to engage with an electronic cigarette device and a second end arranged as a mouthpiece portion having a vapour outlet; the first and second ends defining an axial direction of the capsule, the capsule further comprising:
a vaporising chamber having an air inlet and a vapour outlet;
a storage reservoir configured to store a liquid to be vaporised, the storage reservoir extending between the mouthpiece and the vaporising chamber;
a heating element housed within the vaporising chamber, the heating element configured to vaporise liquid received from the storage reservoir and generate a vapour;
a vapour flow path extending between the vaporising chamber and the mouthpiece to allow the generated vapour to flow from the vaporising chamber to the mouthpiece;
an airflow path extending between an air inlet of the capsule and the air inlet of the vaporising chamber for allowing air to flow into the vaporising chamber; and
a vaporisation flow path located within the vaporising chamber and extending between the air inlet of the vaporising chamber and the vapour outlet of the vaporising chamber to allow vapour to flow out of the vaporising chamber;
wherein the vaporisation flow path extends in a direction of the capsule that is substantially perpendicular to the axial direction of the capsule; and
wherein the airflow path extends in a direction substantially parallel to a longitudinal axis of the capsule.

2. The capsule according to claim 1, wherein the vaporisation flow path extends in a direction substantially parallel to a length of the heating element.

3. The capsule according to claim 1, wherein the heating element comprises a capillary-type heating element.

4. The capsule according to claim 1, wherein the heating element comprises a heating surface delimiting a wall surface of the vaporising chamber.

5. The capsule according to claim 4, wherein the heating surface extends in substantially the same direction as the direction of the vaporization flow path, substantially perpendicular to an axial direction of the capsule.

6. The capsule according to claim 4, wherein the heating element comprises a liquid capillary part sealed from the heating surface by a seal element.

7. The capsule according to claim 4, wherein the heating surface of the heating element comprises a heater track in communication with the capillary part.

8. The capsule according to claim 7, wherein the heater track is printed on the capillary part.

9. The capsule according to claim 7, wherein the capillary part comprises a rigid porous ceramic.

10. The capsule according to claim 4, wherein the heating element has an upper portion comprising the heating surface and a lower portion comprising the liquid capillary part.

11. The capsule according to claim 10, wherein the lower portion is more elongated in the horizontal direction than the upper portion.

12. The capsule according to claim 1, further comprising a seal configured to surround an external surface of the heating element.

13. The capsule according to claim 1, further comprising a holder configured to retain the heating element.

14. The capsule according to claim 13, further comprising a seal configured to surround an external surface of the heating element, wherein the holder is configured to engage with the seal to house the heating element between the seal and the holder.

15. (canceled)

16. (canceled)

17. The capsule according to claim 1, wherein the vapour flow path comprises a vapour flow conduit extending from the vapour outlet of the vaporizing chamber, the vapour flow conduit located next to the storage reservoir.

18. (canceled)

19. The capsule according to claim 1, wherein the vapour flow path comprises a main portion and an end portion and wherein:
the main portion extends between the vapour outlet of the vaporising chamber and the end portion, in a direction substantially parallel to the axial direction of the capsule; and
the end portion extends between the main portion and the mouthpiece.

20. (canceled)

21. (canceled)

22. The capsule according to claim 1, wherein the air flow path comprises an air flow conduit extending between the air inlet of the capsule and the air inlet of the vaporising chamber, the air flow conduit located adjacent the heating element.

23. The capsule according to claim 1, wherein the vapour flow path and air flow path are located substantially on opposite sides of a median plane, the median plane passing substantially through the vapour outlet in the mouthpiece of the capsule.

24. The capsule according to claim 1, further comprising a buffer reservoir in fluid communication with the storage reservoir, and wherein the heating element is arranged to contact liquid stored in the buffer reservoir.

25. An electronic cigarette comprising a main body and a capsule wherein the main body comprises a power supply unit, electrical circuitry, and a capsule seating configured to connect with the capsule, the capsule comprising:
a first end configured to engage with the electronic cigarette device and a second end arranged as a mouthpiece portion having a vapour outlet, the capsule further comprising:
a vaporising chamber having an air inlet and a vapour outlet;
a storage reservoir configured to store a liquid to be vaporised, the storage reservoir extending between the mouthpiece and the vaporising chamber;
a heating element housed within the vaporising chamber, the heating element configured to vaporise liquid received from the storage reservoir and generate a vapour;
a vapour flow path extending between the vaporising chamber and the mouthpiece to allow the generated vapour to flow from the vaporising chamber to the mouthpiece;
an airflow path extending between an air inlet of the capsule and the air inlet of the vaporising chamber for allowing air to flow into the vaporising chamber; and
a vaporisation flow path located within the vaporising chamber and extending between the air inlet of the vaporising chamber and the vapour outlet of the vaporising chamber to allow vapour to flow out of the vaporising chamber;
wherein the vaporisation flow path extends in a direction of the capsule that is substantially perpendicular to an axial direction of the capsule; and
wherein the airflow path extends in a direction substantially parallel to a longitudinal axis of the capsule.
